(19) United States
(12) Patent Application Publication
(10) Pub. No.: US 2008/0130630 A1
(43) Pub. Date: Jun. 5, 2008

(54) SECURE PEER TO PEER MESSAGING SERVICE

(75) Inventors: Eunsoo Shim, Princeton Junction, NJ (US); Sathya Narayanan, Plainsboro, NJ (US)

Correspondence Address: RATNERPRESTIA, P.O. BOX 980, VALLEY FORGE, PA, 19482, US

(73) Assignee: MATSUSHITA ELECTRIC INDUSTRIAL CO. LTD., Osaka (JP)

(21) Appl. No.: 11/949,465

(22) Filed: Dec. 3, 2007

(30) Foreign Application Priority Data
Jul. 7, 2006 (US) PCT/US2006/026297

(51) Int. Cl. H04L 12/66

(52) U.S. Cl. 370/352

(57) ABSTRACT

A message system for a peer-to-peer network stores messages or message fragments at multiple peers when a called peer is off-line. The replicated messages or message fragments may be encrypted. According to a pull model, the called peer polls other peers to which it has access when it comes on-line to determine if a message is waiting. According to a push model, the peers storing the message from the calling peer notify the called peer when it comes on line. The system may employ a single level where only message data is stored or two levels where the primary level holds the address of peers that contain the message data which forms the secondary level.

### FIELD OF THE INVENTION

The present invention relates to the field of peer-to-peer networks and more particularly, to a method and system for secure messaging on a P2P network.

### BACKGROUND OF THE INVENTION

Peer-to-peer (P2P) networks have become increasingly popular with their primary application being file-sharing. A number of users are employing P2P networks for communication, with voice over Internet protocol (VoIP) P2P telephone services, such as Skype® being among the most popular. To use the Skype system between two computers, the users of these computers must be on-line simultaneously.

### SUMMARY OF THE INVENTION

The present invention is embodied in a method for transmitting a message from a calling peer to a called peer in a peer-to-peer network. The method includes the calling peer determining if the called peer is off-line. If so, the message is replicated N times, where N can be determined from a probability that a peer in the peer-to-peer network is on-line and a desired reliability of message delivery. The N replicated messages are transmitted for storage at N respective peers.

The present invention may further be embodied in a method in which, responsive to the called peer being off-line, the message is transmitted to a predetermined number of other peers and is stored in the predetermined number of the other peers that are on-line. Furthermore, responsive to the called peer coming on-line, at least one of the stored messages is sent to the called peer.

The present invention may also be embodied in a method in which, responsive to the called peer being off-line, the message is compressed to generate a reproduction version representing the message that meets or exceeds a threshold quality, the compressed message is transmitted to a predetermined number of the other peers, and the compressed message is stored in at least the predetermined number of the other peers that are on-line. Furthermore, responsive to the called peer coming on-line, at least one of the stored compressed messages is sent to the called peer.

The present invention may further be embodied in a method in which, responsive to the called peer being off-line, the message is decomposed into a plurality of layers such that one or a combination of respective layers represents a version of the message. At least one of the respective layers of the decomposed message is selected that meets or exceeds a threshold quality for a reproduced version of the message. The respective layers of the decomposed message are transmitted to a predetermined number of the other peers and are stored in the predetermined number of other peers that are on-line

The present invention may further be embodied in a peer-to-peer network including a plurality of peers on the peer-to-peer network communicating therein. The peer-to-peer network includes a calling peer for generating a message from a caller, a called peer for receiving the message and providing the message to a called user and storage peers for storing compressed or layered messages from the calling peer. Furthermore, responsive to the called peer being off-line, the calling peer transmits the compressed or layered messages to a predetermined number of the storage peers that are on-line and responsive to the called peer coming on-line, one of the storage peers send a respective message stored therein to the called peer.

The present invention may further be embodied in a peer-to-peer network. The peer-to-peer network includes a calling peer for sending replicated messages and a called peer receiving one or more replicated messages from the calling peer via one or more of mail-box peers, responsive to the called peer becoming available. Each mail-box peer receives and stores at least one respective message destined for the called peer when the called peer is unavailable. Further, each mail-box peer transmits the stored message to the called peer when the called peer becomes available.

### BRIEF DESCRIPTION OF THE DRAWINGS

The invention is best understood from the following detailed description when read in connection with the accompanying drawings. It is emphasized that, according to common practice, various features/elements of the drawings may not be drawn to scale. On the contrary, the dimensions of the various features/elements may be arbitrarily expanded or reduced for clarity. Moreover in the drawings, common numerical references are used to represent like features/elements. Included in the drawing are the following figures:

FIGS. 1, 2 and 3 are schematic views of an exemplary P2P network to illustrate methods of message delivery in accordance with various exemplary embodiments of the present invention;

FIGS. 4A and 4B are schematic views of another exemplary P2P network to illustrate further methods of message delivery in accordance with various exemplary embodiments of the present invention;

FIG. 5 is a block diagram of a peer of a peer-to-peer network for use with certain exemplary embodiments of the present invention; and

FIGS. 6, 7A, 7B, 8 and 9 illustrate flow charts of methods for communication between a calling peer and a called peer in a peer-to-peer network in accordance with various exemplary embodiments of the present invention.

### DETAILED DESCRIPTION OF THE INVENTION

To be viable in the marketplace, future P2P communications systems should desirably support messaging services whereby one user may leave a message for another user, similar to the voicemail feature supported by current telephony systems. The peer devices of most of the current P2P networks are computers. A recent and growing trend in consumer electronics devices, however, has been digitalization of analog devices. Thus, film cameras are replaced by digital cameras and analog televisions are replaced by digital televisions. An evolution in many digital consumer electronics is to be interconnected through networking. P2P technologies are very attractive for networking consumer electronics devices in a number of aspects. For example, if these devices are networked, innovative applications developed by end users may be deployed easily. The networking of consumer electronic devices presents similar problems for the delivery of content to a user when the user is off-line.

The self-organizing feature of P2P networks and their relative simplicity compared to more formal networks are important features for users to establish a private network of consumer electronics devices.

Any such P2P network may desirably support a messaging service. Such a service may support various media including text, voice, video and images, created by various consumer electronics devices. Consumer electronics devices are highly heterogeneous, ranging from high-power personal computers to relatively simple music players. This diversity is a consideration for the system design of any messaging system. Another characteristic of consumer electronics devices is the unreliability of network access, especially in networks with wireless components. That is, even if a device is currently on-line, it may be off-line, at least temporarily, when content is sent.

### Message Privacy

A typical message system, implemented in a conventional client/server architecture, uses message servers that may provide message privacy by user authentication and/or message encryption. Typically, a message is delivered to and stored at a server which controls message storage for the message recipient.

In exemplary embodiments of P2P messaging systems, message servers corresponding to those of the conventional client/server architecture do not exist. Instead, a message may be delivered directly to the recipient when the recipient is on-line and it may be stored by peers when the recipient is off-line. Such a P2P messing system may present certain privacy issues. For example, the peers that are storing (e.g., temporarily) the message may facilitate it being read. Alternatively, someone other than the recipient may gain access to the message stored on the peer.

A typical messaging system, implemented using conventional message servers, may provide message privacy by user authentication and message encryption. These conventional messaging servers typically have large storage capabilities and powerful processors.

Ideally, a P2P messaging system may store messages at peers when the recipient is off-line in a way that ensures that the intended recipient and desirably not the peers of any other node in the network can read the messages. For that, the messages may be encrypted so that it can be decrypted by the intended recipient and possibly by the peer generating the message but desirably not by any third-party peers. For message encryption, the intended peer's public key may be used or a shared secret may be used.

For message authentication, the message may be signed cryptographically by the peer that generated the message. Digital signature methods may be used for the purpose.

### Message Delivery Reliability

Another issue with P2P message systems is that the peers may not be reliable. One or more peers that have stored a message for an off-line recipient may themselves also go off-line before the recipient comes on-line. That is, even though the message is stored for the recipient, the recipient may not be able to access it in a timely manner. In addition, the recipient can not control the activity of peers, which may intentionally or accidentally destroy or damage the message before it can be retrieved by the recipient. One solution for increasing the reliability of message delivery in P2P networks is to store the message in multiple peer mail-boxes. The number of mail-boxes at which the message may be stored is selected to maintain a particular level of reliability (e.g., message delivery). As the number mail-boxes increases, however, the scalability of the system is reduced because of the bandwidth cost and storage cost for distributing the message across a large number of mail-boxes.

The number of mail-boxes (mail-box peers) at which the message is stored may be selected accordingly to maintain a particular level of reliability.

If a mail-box peer in a structured P2P network becomes unqualified at the location of the stored messages while it is on-line, it may transfer the stored messages to the proper peers. For example, in a DHT-based P2P network, if a new peer joins the network and changes the P2P network topology, the DHT algorithm may move some or all of the stored messages from the current mail-box peer to the new peer because the new peer's ID is closer to the message ID. Thus, it may be assumed that any messages stored at the peer may be retrieved, as long as the mail-box peer is on-line. This movement of stored messages applies only for structured P2P networks. If the P2P is unstructured, peers typically do not transfer messages among themselves due to topology changes.

To ensure delivery of a message, it is desirable to replicate or propagate the message in a plurality of peer mail-boxes so that if one or more of the peers is off-line when the recipient goes on-line, the message may still be timely delivered. In certain exemplary embodiments, the replication method may provide a copy of the whole message at each selected mail-box peer to which the message is being sent. This technique is referred to herein as “whole message replication.” Whole message replication may be suitable for messages of relatively small size.

Another technique is to store only a part of the message in each mail-box peer. For this scheme a set of peers having sufficient component parts to reproduce at least some version of the message is desirably on-line when the recipient goes on-line. In accordance with various exemplary embodiments, two replication methods using partial message components are described as follows: (1) replication methods with progressive layering; and (2) replication with hierarchical layering. In each of these methods, the partial message components may be stored in mail-box peers and retrieved by a called peer.

### Progressive Layering Based Replication

Progressive layering refers to a layering technique in which a plurality of layers may be added to improve the quality of the decoded content even if one or more other layers are missing. That is, each layer is independent of the other layers.

### Hierarchical Layering Based Replication

Hierarchical layering refers to another layering technique in which a plurality of layers may be added to improve the quality of the decoded content only if the layers under (hierarchically under) a particular layer to be added are available. An example of the latter approach is the hierarchical coding a JPEG encoded image, in which an upper layer is generated as a difference between an image of a target resolution and the image generated with lower layers. This makes the upper layer useless without the lower layers. Placing data of an upper layer separately from its lower layers just increases the possibility that the upper layer data is retrieved while one or more of its lower layers are missing so that the retrieved upper layer is useless and the bandwidth and the storage space of that upper layer are wasted.

The inventors have developed an analytical model to predict the number of replications to probabilistically achieve a desired level of reliability for message delivery to a called peer (i.e., a recipient). In this model, the following notations are used: (1) the information quantity in the whole message is I; (2) the average information retrieved is <Iᵣ>; (3) the message size is m (bytes); (4) the probability of a peer being on-line is Po; and (5) the probability that an on-line peer can be discovered is Pd. In the materials that follow, upper layers are denoted by smaller numbers and lower layers are denoted by larger numbers.

To model the quality of a received image, a metric ‘information amount’ may be used. If the amount of information in a whole message is denoted by I and the amount of information in layer i is denoted by Iᵢ then the number of replication of layer i may be Nᵢ and Iᵢ=αᵢI where αᵢ of determines the proportion of the information in layer i and Σᵢ^{L}αᵢ=1 where L=the number of layers. The amount of information I may be determined using known techniques such as, the Mean-Opinion-Score (MOS), Peak Signal-to-Noise Ratio (PSNR) or Mean-Square-Error (MSE).

The information quantity of each layer or αᵢ depends on the content and the specific layered coding technique. If the order of layers are arranged so that the lower layers contain more information than the higher layers, that is, information is concentrated in lower layers, and each replication of every layer may be placed on a different mail-box peer (so that retrieval of each layer is independent of other layers), successful layer i retrieval probability vᵢ is vᵢ=1−(1−P)^{N}^{ᵢ}. The average retrieved information <Iᵣ> is

$$\begin{matrix}〈 {I}_{r} 〉 = {\sum }_{I}^{L} {I}_{i} {v}_{i} \\ = {\sum }_{I}^{L} I {α}_{i} ( 1 - {( 1 - P )}^{{N}_{I}} ) \\ = I - I {\sum }_{i}^{L} {{α}_{i} ( 1 - P )}^{{N}_{I}}\end{matrix}$$

### The information retrieval ratio <Iᵣ>/I is

$$〈 {I}_{r} 〉 / I = 1 - {\sum }_{I}^{L} {{α}_{i} ( 1 - P )}^{{N}_{I}}$$

In certain exemplary embodiments, any upper layer, may be stored with its corresponding lower layers such that, for example, if layer 3 is stored at a mail-box peer, then layer 1 and 2 may also be stored at the same mail-box peer. In this scheme, layer groups may be formed where, for example, group j includes data of layers 1, 2, . . . , and j. The information in group j is I′ⱼ and the mail-box peer count for group j is N′ⱼ. I′ⱼ=I₁+I₂+ . . . +Iⱼ and N′ⱼ=Nⱼ−Nⱼ₊₁ for j=1 to L−1 and N′_{L}=N′_{L}. Since a mail-box peer storing group L contains all the layers from 1 to L, once this mail-box peer is on-line, the information from the other groups from 1 to L−1 is not necessary. That is, the information stored mail-box peers associated with in groups L−1 is useful only if no mail-box peer having group L is on-line. Therefore, v′ⱼ is the probability of at least one mail-box peer in group j being on-line, The inventors have determined that the average retrieved information <Iᵣ> is

$$\begin{matrix}〈 {I}_{r} 〉 = {\sum }_{I}^{L} {I}_{j}^{′} {v}_{j}^{′} {\prod }_{I = j + 1}^{L} ( 1 - {v}_{I}^{′} ) \\ = I {\sum }_{j}^{L} ( 1 - {( 1 - P )}^{{N}_{j}^{′}} ) {\sum }_{k = 1}^{j} {α}_{k} {\prod }_{i = j + 1}^{L} {( 1 - P )}^{{N}_{I}^{′}}\end{matrix}$$

and that the average retrieved information ratio <Iᵣ>/I is

$$〈 {I}_{r} 〉 / I = {\sum }_{j}^{L} ( 1 - {( 1 - P )}^{{N}_{j}^{′}} ) {\sum }_{k = 1}^{j} {α}_{k} {\prod }_{i = j + 1}^{L} {( 1 - P )}^{{N}_{I}^{′}}$$

The probability that an individual mail-box peer can be reached is P=Po×Pd. The peer discovery probability is the probability of successful discovery of a particular peer (mail-box peer) when the recipient peer is on-line, which may not be less than 1, in certain instances. If, for example, a message flooding method is used with such messages having only a limited time-to-live P may be less than 1. Time-to-live refers to a period of time or number of iterations or transmissions that a message may experience before it is discarded. In such a case, the recipient peer may not find the mail-box peer storing the message within the limited time-to-live. That is, the on-line mail-box peer may not be able to be reached because it is too many hops away from the recipient peer. Also, with a DHT, a lookup message may fail to reach a mail-box peer when the DHT routing tables are unstable.

The message desirably may be replicated N times such that the information retrieval ratio, <Iᵣ>/I is close to unity. The inventor have determined that, <Iᵣ>/I=1−(1−P)^{KN}. Thus, N can be calculated as N=log(1−Pᵣ)/Klog(1−P) where K is the number of times the recipient peer attempts to contact each mail-box peer, and Pᵣ is the probability of successful message delivery. Table 1 shows the number N of replications to achieve a probability of successful message delivery of Pᵣ given K the number of attempts to contact each mail-box peer and P the probability that an individual mail-box peer can be reached.

TABLE 1
NUMBER OF REPLICATIONS

| K | Pᵣ | P | N |
|---|---|---|---|
| 1 | 0.99 | 0.01 | 459 |
| 1 | 0.99 | 0.1 | 44 |
| 1 | 0.99999 | 0.01 | 1146 |
| 1 | 0.99999 | 0.1 | 110 |
| 10 | 0.99 | 0.01 | 46 |
| 10 | 0.99 | 0.1 | 5 |
| 10 | 0.99999 | 0.01 | 117 |
| 10 | 0.99999 | 0.1 | 12 |

Table 1 shows the number of replications to achieve 99.999% is 110 when P is 0.1 and 1146 when P is 0.01. N gets very large as the peer on-line probability is reduced, which may be the case if the P2P network includes a large number of portable consumer devices that are on-line only during limited times of a day. One way to reduce the number of replications is to have the recipient peer check the existence of any stored message multiple times. Such check desirably occurs at spaced apart intervals. The probability of successful retrieval after K attempts is also shown in Table 1. In particular, as the number of attempts to contact mail-box peers increases, the number of replications decreases in an inversely proportional relationship. That is, the number of replications may be reduced by 1/K, however, the average delay in message delivery increases from T to KT, where T is the time interval between retrieval attempts.

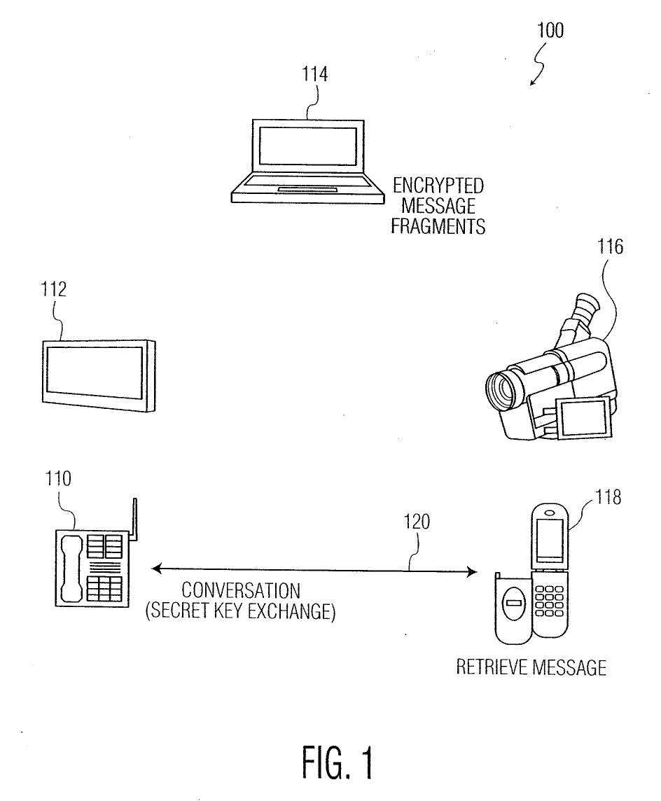

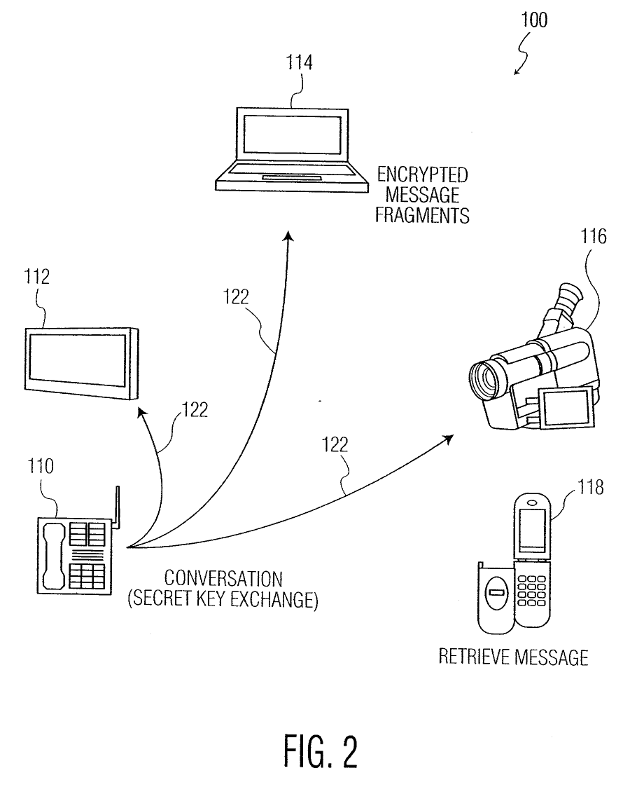

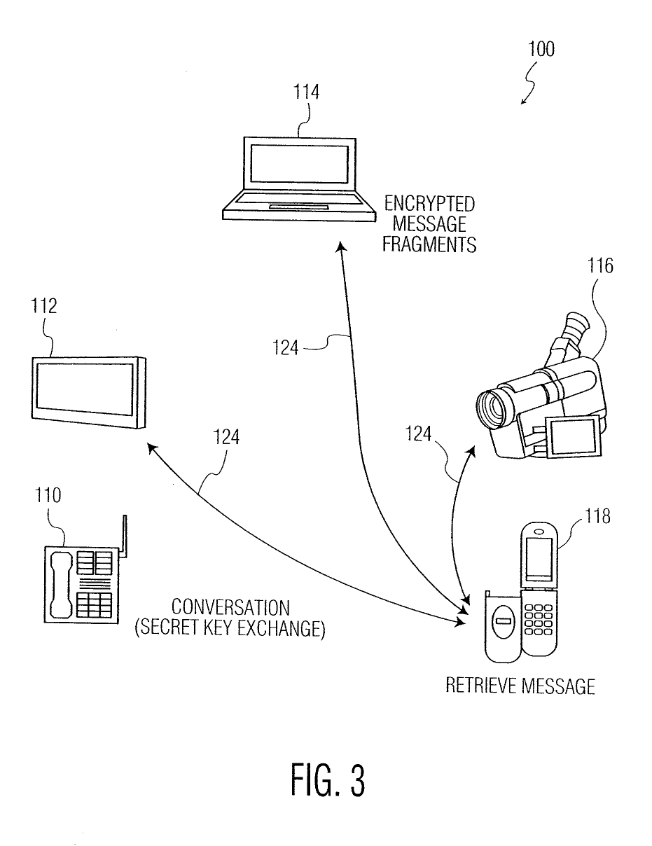

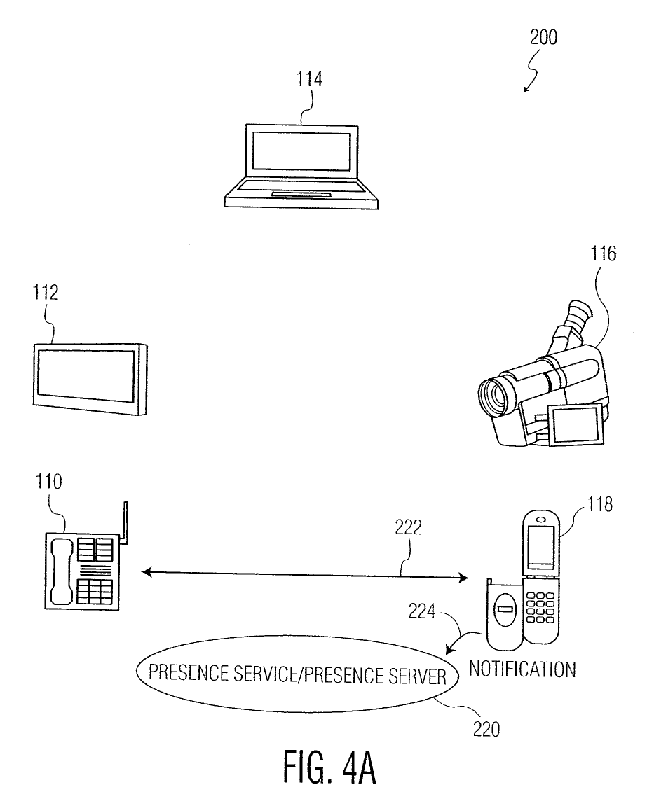

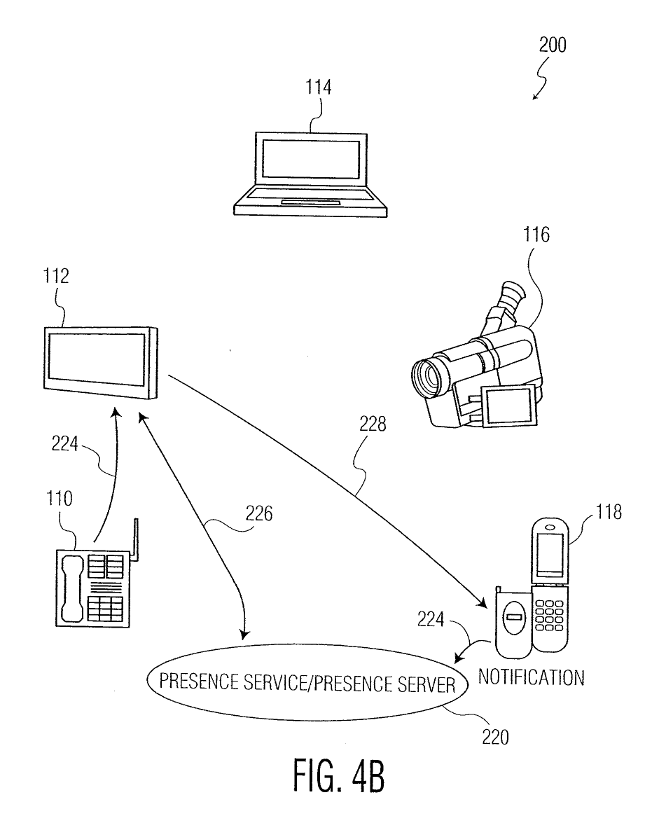

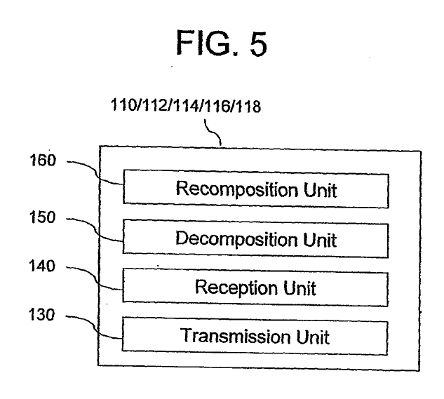

Two message retrieval models are possible, a Pull Model and the Push Model. According to the Pull Model, when the recipient comes on-line it finds the stored messages where they are stored. In this model, the recipient initiates the message retrieval procedure by contacting the storing peers. The Pull Model is described below with reference to FIGS. 1-3. In the Push Model, the storing peers (called mail-box peers) find the recipient when it comes on-line and initiate the message retrieval procedure by contacting the recipient. The Push Model is described below with reference to FIGS. 4 and 5.

Although the Push Model and Pull Model are illustrated separately, it is contemplated that various exemplary embodiments of the present invention may include either or both models for the transfer of the replicated messages from the storing peers to the recipient. That is, the storing peers may monitor to find the recipient when it comes on-line and initiate the message retrieval procedure by contacting the recipient and/or when the recipient comes on-line it may find the stored messages where they are stored. If used together, once a message (or message fragments) are transferred from a respective storing peer to the recipient, the process is complete with respect to the respective storing peer.

Although certain exemplary embodiments illustrate that the messaging service is automatic (e.g., that messages are sent between peer without human intervention), it is contemplated that the messaging service may be controlled by one or more users. For convenience, in the materials that follow an action initiated by a peer may be initiated automatically or under the control of a user.

FIGS. 1, 2 and 3 are schematic diagrams of an exemplary P2P network to illustrate methods of message delivery in accordance with various exemplary embodiments of the present invention.

Now referring to FIGS. 1, 2 and 3, an architecture for the Pull Model is shown in FIGS. 1-3. This exemplary P2P network includes five peers, 110, 112, 114, 116 and 118. In the exemplary P2P network, peer 110 desires to send a message to peer 118 which is off-line. Prior to sending the message, at a time when both peers 110 and 118 were on-line, they exchanged a secret key that is used to encrypt the message contents, as indicated by the arrow 120. At the current time, when peer 110 desires to send a message to the off-line peer 118, peer 110 may fragment the message into encrypted pieces and may transmit the pieces to peers 112, 114 and 116 (see arrows 122). When peer 118 comes on-line, it may poll a portion or all of the on-line peers (see arrows 124) to determine if they have stored any messages for peer 118 and, if so, may request transfer of the messages. Peer 118 may then decrypt and reassemble the message parts.

In such a scheme first time contact may be handled by storing the message only at calling peer 110 and, when called peer 118 comes on-line, exchanging both the message and a secret key to be used to decrypt any future messages. Calling peer 110 may leave a voicemail notification at the other peers 112, 114 and 116, to inform called peer 118 that a message is waiting. Called peer 118 then may try to catch calling peer 110 when they are both on-line.

Using the Pull Model, the message fragments may be stored at only those peers 112, 114 and 116 that are accessible to called peer 118. One way to ensure accessibility is for called peer 118 to determine a list of candidate URL locations for peers (for example, peers 112, 114 and 116) that it can reach and transmit this list to calling peer 110 at the same time the secret key is exchanged. Later, when calling peer 110 sends a message to the off-line called peer 118, it sends the message to the peers on the URL list.

It is contemplated that in certain exemplary embodiments fragments may overlap so that not all of the fragments need to be recovered in order to reproduce the initial message.

Alternatively, a multi-level scheme may be used in which the actual messages (i.e., primary level messages—level 1) are stored in selected locations and only meta data (i.e., including location information—level 2) about the stored primary level messages is stored at other selected locations. Because the metadata is relatively small, it may be stored at many locations while the entire encrypted or unencrypted message may be stored at a smaller number of locations, some of which may not be on the called peer's list of URLs. These locations may be selected, for example, because they have a high probability of being on-line (Po).

Although the messages are described as being encrypted, it is contemplated that, based on their sensitivity or other factors such as peer processing power, system bandwidth and other security measures of the P2P network, among others, they may not be encrypted. If they are encrypted, they may be encrypted by several different methods including the shared key method, described above, or with a public key in a public-key, private-key system. The peers used to store the message may be selected according to (1) a prearranged group; (2) their proximity to the recipient based on the structured network using, for example DHT entries, and/or (3) a random selection. The selection may be agreed to between calling peer 110 and called peer 118, for example, during the initial exchange of secret information. The message may be stored in fragments or as a whole message. The number of replications may be selected to achieve a desired probability of reception. This probability may vary with the importance of the message which may be set by the caller for a particular message or automatically by the calling peer, based on preference set by the caller.

If two-level storage is used, primary mail-boxes and secondary mail-boxes may be defined. The secondary mail-boxes may be mail-boxes that are initially contacted by calling peer 110 or called peer 118 for message storage or retrieval. These mail-boxes may contain the location or locations of the primary mail-box or mail-boxes, which store the message (or its message fragments). Although they are described as being separate, the distinction between primary and secondary mail-boxes is a logical distinction. That is, some of the primary mail-boxes may also act as the secondary mail-boxes.

Selection of the primary mail-boxes may be arbitrary as their addresses may be provided by the secondary mail-boxes and, thus, may be reached by called peer 118 using normal addressing mechanisms. The primary mail-boxes may be selected based on their storage space and/or based on load balancing of messages over the P2P network. Reliability is increased by selecting many secondary mail-boxes. As described above, the functions performed by a secondary mail-box are relatively inexpensive because the stored information (i.e. the metadata including the address or addresses of the primary mail-box or mail-boxes) is small.

If single-level storage is used, the primary mail-boxes store the message and there is no secondary mail-box. In this scenario, the primary mail-box or mail-boxes are desirably easily accessed by called peer 118. These mail-boxes may be selected in the same way as for the secondary mail-boxes of the two-level system. Using DHT, for example, the called peer's identifier (or its variation according to predefined rules) may be mapped into a resource ID according to the underling DHT mechanism. Calling peer 110 may then contact the peer node in charge of the resource ID and may use this node as the (first) primary mail-box (i.e., a mail-box peer). When multiple primary mail-boxes are required, DHT specific rules may be used to identify the other peers.

As an example, if the P2P network is built with a Chord topology (see e.g. Frank Dabek et al., “Building Peer-to-Peer Systems With Chord, a Distributed Lookup Service,” MIT Laboratory for Computer Science), consecutive peer nodes starting from the first primary mail-box peer (node) may be selected. The advantages of using a structured P2P network with accessible primary mail-box peers almost guarantees success of message checking and reasonable speed (assuming reasonable DHT performance).

Alternatively, the single-level storage system may be implemented in an unstructured P2P. In this scenario, the sender may randomly pick R peers for storage. The receiver may then issue a search for stored messages using a predefined name. The main advantage of this system is its simplicity. If it is possible to pick peer nodes proximate to the called peer as the primary mail-boxes, the reliability and time latency of the message checking may be improved (in particular, if flooding is used for the search).

In a single-level system, the primary mail-box peers may also be prearranged, for example, by using the URL list. This scheme encourages peers to interact with other peers to gain permission to serve as primary mail-boxes. Mutuality of service between peers leads to rewarding more cooperative (social) peers. It is relatively easy to verify the sincerity of a peer by randomly trying to leave a message at group members with cooperation of another peer.

According to certain exemplary embodiments, during a session, peers may exchange a list of mail-box peers. Some of the prearranged mail-boxes then may be used as the primary mail-boxes when the called peer 118 is off-line. The advantages of this scheme is that it is efficient and reliable, there is no overhead for DHT maintenance, it is easily scalable and it promotes cooperation and rewards social nodes. This single-level system (method) may be used with another method that handles first contact, for example, between calling peer 110 and called peer 118.

According to certain exemplary embodiments, mail-box peers 112, 114 and 116 may inform called peer 118 of the existence of stored messages destined for called peer 118 or the users of called peer 118. Called peer 118 or the user of called peer 118 may select some or all these messages and may retrieve them from the appropriate mail-box peer 112, 114 or 116. That is, called peer 118 may first receive the list of messages from the mail-box peers 112, 114 and 116 and then the actual message delivery may occur after the called peer 118 or the user of called peer 118 determines (selects) some or all of the messages for retrieval.

FIGS. 4A and 4B are schematic views of another exemplary P2P network to illustrate further methods of message delivery in accordance with various exemplary embodiments of the present invention.

Now referring to FIGS. 4A and 4B, an architecture of a Push Model is shown in FIGS. 4A and 4B. This exemplary network may include peers 110, 112, 114, 116 and 118. It also may includes a presence service 220. Presence service 220 refers to a service which tracks at least the presence of peers on peer-to-peer network 200. For example, the presence service may include one or more servers/peers responsible for tracking the presence of a peer (e.g., which peers on the peer-to-peer network 200 are currently on-line) and for notifying, for example, a mail-box peer that a call peer is on-line. An exemplary push model may operate as follows, calling peer 110 randomly picks R peers for storage. Each mail-box peer receives only a part of the message, not enough to re-create the complete message. Each message piece may include information about the recipient 118 (i.e., the called peer) so the mail-box peers 112, 114 and 116 may subscribe to the presence of the recipient. That is, these mail-box peers use the presence service (or presence server) 220 to determine when called peer 118 is on-line. When called peer 118 comes on-line, each mail-box peer 112, 114 and 116 may learn this through the presence service 220 and may deliver their message pieces to the recipient 118. It may be desirable to have a secure P2P presence service.

The selection of mail-box peers 112, 114 and 116 may be made according to the following criteria. If the message fragment stored at each mail-box peer is not encrypted, the fragment is desirably small enough so that collecting some of the fragments is not enough to reconstruct the original message or to figure out any important information. In this instance, the mail-box peers 112, 114 and 116 may be randomly selected so that they cannot be predicted. In addition, the total number of peers may be sufficiently large to prevent scanning by an attacker to steal the message. Thus, the push model may include a message encryption method, for example, no encryption, encryption with a shared key, or encryption with a public key. Encryption with a public key has the advantage of being very secure with the proper infrastructure. As with the pull model, the number of replications used to achieve a desired level of reliability may be predetermined or based on measured quantities such as on-line times of various peers in the P2P network.

The advantages of a shared key are mainly its ability to be used without additional infrastructure. Shared key establishment, however, is vulnerable to man-in-the-middle attack, for example, using the Diffie-Hellman algorithm. As with the pull method, to reduce or prevent such man-in-the-middle attacks, the shared keys may be changed while both calling peer 110 and called peer 118 are on-line. This may be accomplished by leaving only a notification that a message exists at selected mail-box peers 112, 114, and 116.

The inventors have developed a message transfer scheme using content-aware message fragmentation for P2P networks. For text messages, the scheme may break the message into equal priority pieces and may create an approximately equal number of replications for each piece. Text messages that include attachments, however, may allow for a content-aware fragmentation scheme. In such an exemplary scheme the message or the message parts may be replicated a larger number of times than the attachments and they may be sent to a larger number of mail-box peers than the attachments, thereby, increasing the probability that the message will be able to be retrieved by the called peer.

For video and images such as JPEG encoded pictures, the content-aware method may divide (decompose) the image into layers. Each layer having a different priority with the primary layer having the highest priority. The scheme then breaks each of the layers into pieces and replicates the higher priority layers more times to increase the probability of arrival at the called peer. The number of replications may be based on the image content of each layer. That is, as the image content approaches that of the original image, the number of replications may increase. Layers or layer fragments may be sent to a corresponding number of mail-box peers. For video data, the method, alternatively, may use multiple description coding and may follow a similar priority scheme.

As described above, in the pull model, the number of replications N for a message—or a message part—may be determined according to the formula N=log(1−Pr)/log(1−P) where K=1. In some instances, especially when Pr or Po are small, N may be very large. One way to reduce the size of N is to allow the called peer to try to retrieve its messages more than once, where the multiple tries are distributed in time such that Pr=1−(1−P)^{NK}. In this case, the number of replications is N=log(1−Pr)/Klog(1−P). This may greatly reduce the number of replications needed to achieve a desired reliability.

It should be understood that the method illustrated may be implemented in hardware, software, or a combination thereof. In such embodiments, the various components and steps described below may be implemented in hardware and/or software.

In certain exemplary embodiments, the message destined for the called peer may be partitioned into fragments and the message fragments may be either replicated and sent (i.e., transmitted in parallel to) the respective mail-box peers 112, 114 and 116 or, propagated, e.g., sent and forwarded to the mail-box peers 112, 114 and 116 (i.e., serially sent from one mail-box peer 112, 114 or 116 to the next mail-box peer).

In certain exemplary embodiments, called peer 118 may receive a list of messages destined for it first, and then may initiate delivery of messages selected by called peer 118 or the user of called peer 118 based on the received list. That is, for example, the called peer may initiate delivery of some or all of the actual messages selected by called peer 118 or the user of called peer 118 based on the received list of messages.

FIG. 5 is a block diagram of a peer of a peer-to-peer network for use with certain exemplary embodiments of the present invention.

Now referring to FIG. 5, each peer 110, 112, 114, 116 or 118 may include a transmission unit 130 and a reception unit 140 for communication with, for example other peers 110, 112, 114, 116 or 118 or presence service 220. That is, each peer may communicate wirelessly via an antenna (not shown) or through a wired connection (not shown).

Each peer 110, 112, 114, 116 or 118 may further include a decomposition unit 150 for decomposing a message into a plurality of layers such that at least one combination of respective layers represents a version of the message, for selecting at least one combination of the respective layers of the decomposed message to meet or exceed a threshold quality for a reproduced version of the message, and for transmitting via the transmission unit 130 the at least one combination of the respective layers to a predetermined number of other peers of the plurality of peers. For example, the decomposition unit 150 may decompose the message into a plurality of layers. One or a combination of respective layers may represent a version of the generated message. That is, each layer decomposed by the decomposition unit 130 may individually represent a component of the decomposed message (as an example, a frequency component or a spatial component of the decomposed message).

Each peer 110, 112, 114, 116 or 118 may also include a recomposition unit for reconstructing a decomposed message by combining the at least one combination of the respective layers to produce the reconstructed version of the message. That is, for example, called peer 118 may receive one or more of the stored layers or layer fragments corresponding to the message destined for the called peer 118 and the recomposition unit 160 may reconstruct a version of the message destined for the called peer 118.

Although, peers 110, 112, 114, 116 or 118 are illustrated having a decomposition unit 150 and a recomposition unit 160, it is contemplated that for certain exemplary embodiments, neither of these units may be included in a respective peer 110, 112, 114, 116 or 118 or only one or these units may be included in a respective peer 110, 112, 114, 116 or 118.

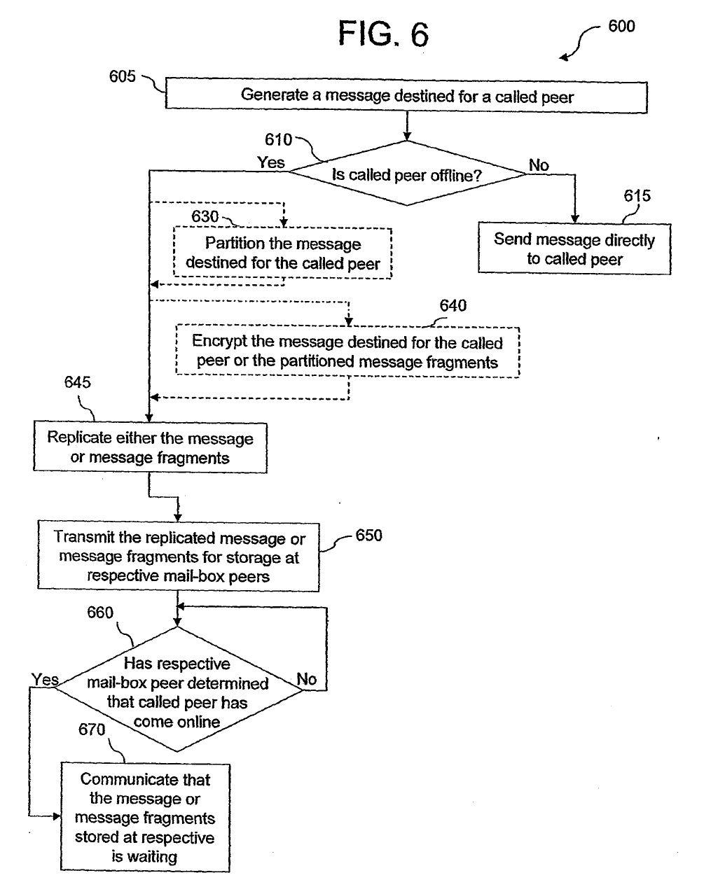

FIGS. 6, 7A, 7B, 8 and 9 illustrate flow charts of methods for communication between a calling peer and a called peer in a peer-to-peer network in accordance with various exemplary embodiments of the present invention.

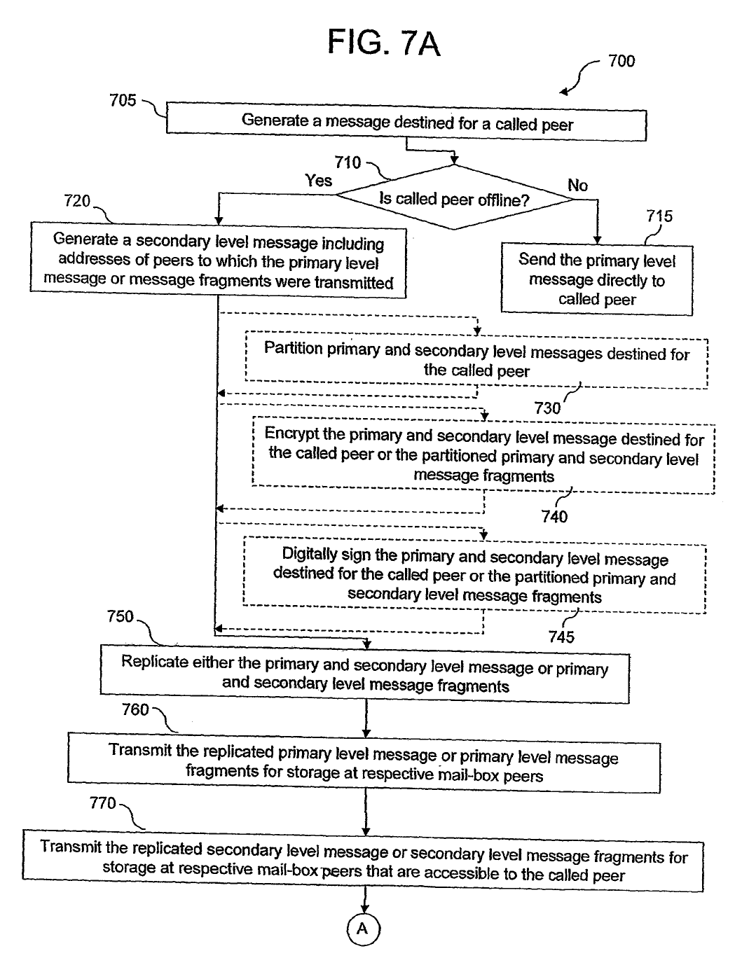

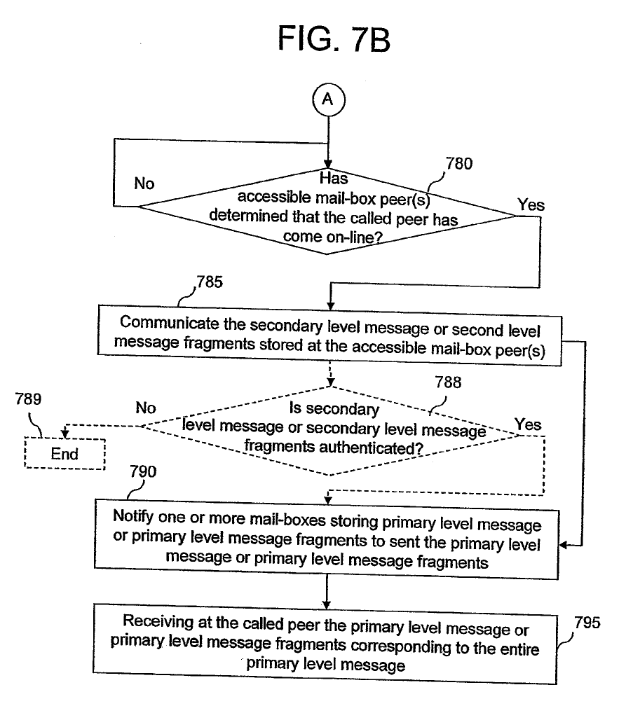

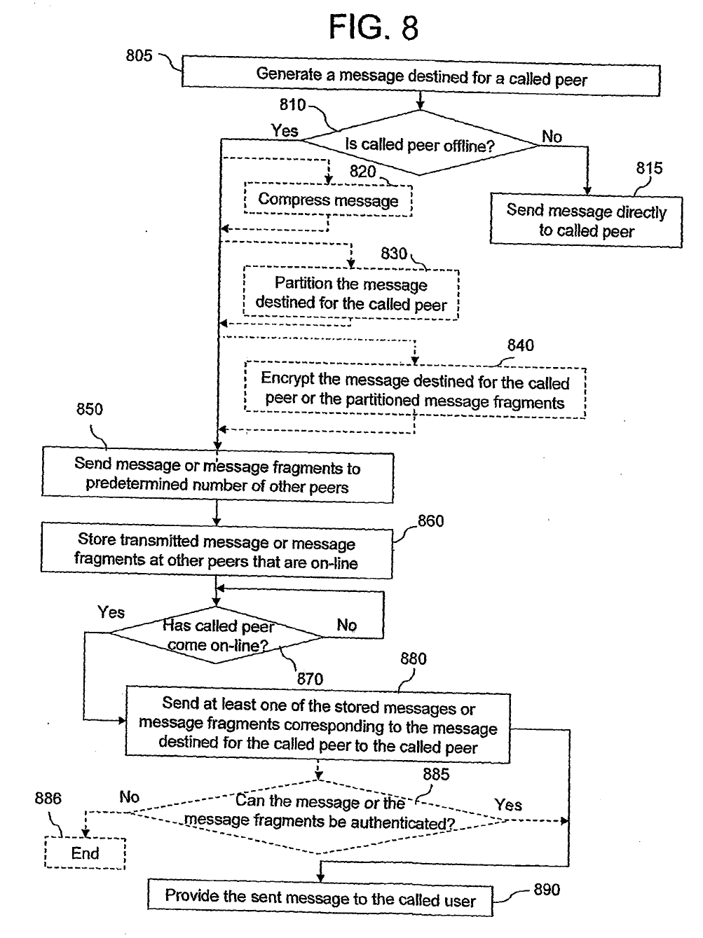

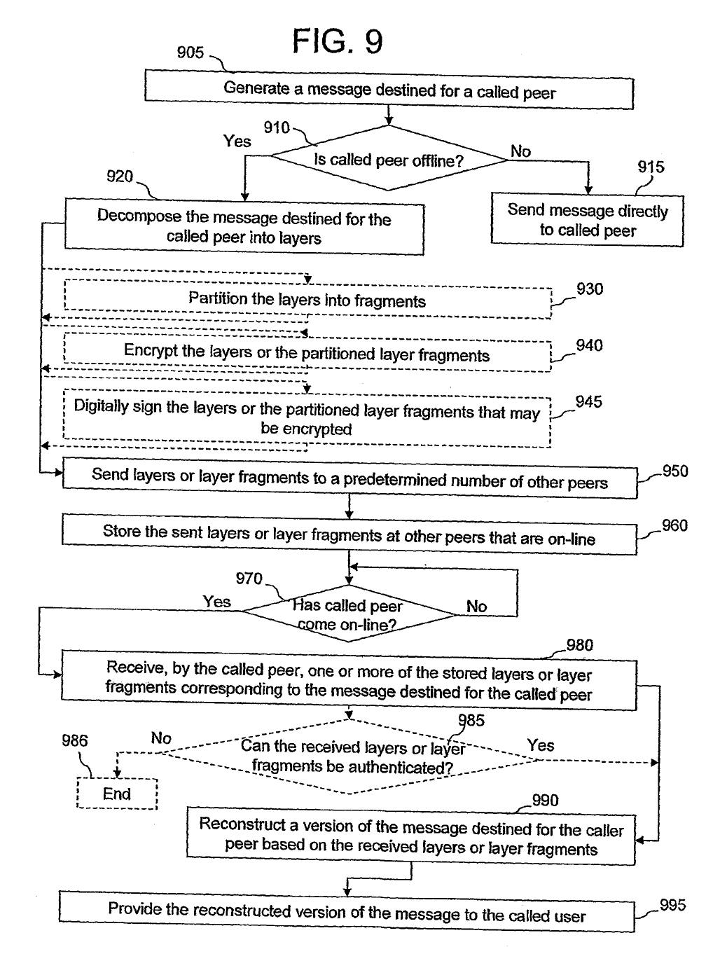

FIG. 6 illustrates, for example, whole message transfer of a message using mail-box peers. FIGS. 7A and 7B illustrate the use of primary and secondary level messages and storage/transfer of these messages using mail-box peers. FIG. 8 illustrates message compression and storage/transfer of the compressed message using mail-box peers. FIG. 9 illustrates message decomposition into layers, storage/transfer using mail-box peers and reconstruction of a version of the message from the received layers.

Now referring to FIG. 6, at block 605, the message destined for the callee (i.e., a called user) via a called peer 118 of peer-to-peer network 100 (shown in FIG. 1) or 200 shown in FIG. 4A is generated. The message may be a text message, an image, a voice message, a video message or any combination thereof and may be generated from any number of different devices such as cell phones, computers, personal digital assistants, and recording devices, among many others.

At block 610, calling peer 110 may determine if called peer 118 is off-line (e.g., is inactive, inaccessible, unavailable or, otherwise, has left peer-to-peer network 100). At block 615, if called peer 118 is on-line (e.g., active and accessible), calling peer 110 may send a message destined for called peer 118 to it. This message sent to called peer 118 may be sent via conventional peer-to-peer network routing, since calling peer 110 and called peer 118 are both on-line.

In certain exemplary embodiments, the message may be processed by calling peer 110 prior to transmission to called peer 118 to fragment the message in preparation for packet transmission over a packet-type network such as the Internet and/or the message may be encrypted to prevent discovery of the message content by those without the proper decryption key or keys. The called peer 118 may have been previously provided with an appropriate decryption key.

At optional block 630, if called peer 118 is off-line, the message destined for called peer 118 may be partitioned into fragments, for example, for transmission over the Internet and/or to enable spreading of the message over a large number of mail-box peers 112, 114 and 116, for example, to improve security of the message (e.g., to make reconstruction of the spread fragments difficult or practically impossible).

At optional block 640, the message destined for called peer 118 which may have been fragmented at block 630 may be encrypted. That is, if the message is fragmented, each message fragment may be encrypted individually and, otherwise, the entire message may be encrypted. Moreover, at optional block 640, the message destined for called peer 118 which may have been fragmented also may or may not be digitally signed to authenticate the message or message fragments. That is, if the message is fragmented, each message fragment, which may be encrypted, may be individually digitally signed. Alternatively, the entire message, which may be encrypted, may be digitally signed.

At block 645, calling peer 110 may replicate the message or message fragments from block 630 that are destined for called peer 118 N times. N may be a predetermined number and may be, for example, based on a probability that respective peers 110, 112, 114, 116 and 118 in peer-to-peer network 100 or 200 are on-line and on a desired reliability of message delivery. The probabilities may be based on an average probability or, otherwise, may include probabilities related to a portion or all of the individual peers on peer-to-peer network 100 or 200. For example, the on-line probability of the calling peer 110 may affect the number of replications of the message or message fragments.

Although it is illustrated that the encryption and/or digital signature step at block 640 occurs prior to replication, it is possible to replicate the message or message fragments prior to encryption and/or the digital signature step. In such a case, for example, each replicated message or message fragment may be individually encrypted.

At block 650, calling peer 110 may transmit the N replicated messages or replicated message fragments corresponding to the N replicated messages for storage at respective mail-box peers 112, 114 and 116 of peer-to-peer network 100 or 200. Mail-box peers 112, 114 and 116 used for storage of the message or message fragments may be: (1) selected randomly or in a quasi-random manner; (2) selected based on the locality of the mail-box peer 112, 114 or 116 to called peer 118; and/or (3) preselected (i.e., prearranged).

The selection of mail-box peers 112, 114 and 116 in a random manner or in a substantially random manner may involve, for example, routing a message or message fragment a random number of hops using a randomly selected distributed hash table entry at each hop. Such a scheme may be applied from any random number of at least a minimum length generated from a conventional random number generator by segmenting the generated random number into such routing information. That is, for example, a first segment of the random number may correspond to a number of hops in the peer-to-peer network, a second segment of the random number may correspond to a selected entry in the distributed hash table (DHT) to route the replicated message or message fragment to a first routed peer (e.g., peer 112).

After reception of the replicated message or message fragment by the first routed peer based on the selected entry in the DHT of the calling peers 110, the number of hops is decremented by 1 and a third segment of the random number may correspond to a selected entry in the distributed hash table (DHT) of the first routed peer 112 to route the replicated message or message fragment to a second routed peer (e.g., peer 116). These operations may be repeated until the number of hops is decremented to 0. Responsive to the number of hops being decremented to 0, if the routed peer does not already have the particular replicated message or message fragment stored, then it may store the particular replicated message or message fragment. If the particular replicated message or message fragment is already stored in the routed peer, then an additional hop may occur randomly based on one of the DHT entries of the routed peer to a further routed peer. If the particular replicated message or message fragment is not stored in the further routed peer, then that message or message fragment may be stored in the further routed peer. The additional hoping sequence may be repeated until a routed peer is found that does not have the replicated message or message fragment stored in it.

Depending on the topology of the peer-to-peer network, (e.g., a chord topology, a pastry topology) each peer may have other neighboring peers. That is, neighboring peers may be, for example: (1) in a chord network, one, two or three hops away from the called peer; or (2) in a branching type network, on a common branch as the called peer. In such networks, the message or message fragments may be stored in proximity (at a neighboring peer) to the called peer. Moreover, for structured networks such as chord networks, the message or message fragments may be stored in peers that would be responsible for resource IDs of the called peer if the called peer were off-line. For example in a chord network, this may be a sequence of N successor peers to the called peer. In such a situation, when the called peer comes on-line, the message or message fragment may be provided to the called peer as part of the called peer joining to the peer-to-peer network.

Mail-box peers 112, 114 and 116 may also be selected in advance (i.e., prearranged) between calling peer 110 and called peer 118 such that when called peer 118 comes on-line, called peer 118 knows in advance to check certain mail-box peers 112, 114 and 116 for messages or message fragments. In this way, mail-box peers 112, 114 and 116 may be pre-selected based on: (1) proximity; (2) security concerns (i.e., selection of friendly peers, peers that may be co-owned, as an example); and/or (3) the probability that certain peers are on-line (thereby reducing the number of replicated messages to be transmitted), among others.

If the message is fragmented: (1) the message fragments representing the entire message may be transmitted together to a respective mail-box peer 112, 114 or 116 or (2) each message fragment may be individually transmitted to a respective, selected mail-box peer 112, 114 or 116. That is, an entire message may be stored at each respective mail-box peer 112, 114 or 116 that is on-line or each individual message fragment, for example, may be transmitted randomly to any mail-box peer 112, 114 or 116 and stored at that mail-box peer 112, 114 or 116 if it is on-line. The latter approach increase security of the message and may be desirable, for example, if the message fragments are not encrypted.

Although message replication or message fragment replication and transmission are described, it is contemplated that the message or message fragments may be propagated (sent and forwarded) from one mail-box peer 112, 114 or 116 to the next mail-box peer 112, 114 or 116. That is, instead of sending replicated message or message fragments in parallel, they may be sent serially (from one mail-box peer to the next mail-box peer) to the respective, selected mail-box peers until the message is propagated to the appropriate number of peers. Such propagation of the message may reduce the overall messaging capacity used in the peer-to-peer network for such a messaging service.

At block 660, each of the mail-box peers 112, 114 and 116 may determine if called peer 118 has come on-line (e.g., is active and accessible). The determination whether called peer 118 has come on-line may be based on: (1) called peer 118 notifying a prearranged group of mail-box peers 112, 114 and 116 that it has come on-line; (2) called peer 118 broadcasting that it has come on-line to other peers known (e.g., accessible) to it; (3) each mail-box peer 112, 114 or 116 polling called peer 118 and determining whether called peer 118 has come on-line based on reception of a response from called peer 118; and/or (4) use of a presence service 220 (for example, one or more servers or peers responsible for tracking the presence of a peer (which peers on peer-to-peer network 200 are currently on-line) and for notifying, for example, a subscribed mail-box peer (e.g., mail-box peer 112) that called peer 118 is on-line. The presence service may include devices which are in the peer-to-peer network 200, such as peers, and/or may include other devices, such as servers, gateway devices and other microprocessor equipment, among others which are external to peer-to-peer network 200.

Presence service 220, for example, may receive a notification 224 from called peer 118 that it is on-line. Each mail-box peer 112, 114 or 116 may send a query to presence service 220 asking whether called peer 118 is on-line. Presence service 220 may respond to the query by providing a notification 226 that called peer 118 is either currently on-line or off-line. The query may include a time-to-live indication (a timeframe for extended notification to the mail-box peer that sent the query, e.g., mail-box peer 112, 114 or 116, to indicate a change in status (e.g., on-line or off-line) of called peer 118. That is, if called peer 118 notifies presence service 220 prior to the end of the time-to-live period that it is on-line, presence service 220 may automatically send a notification to the particular mail-box peer 112, 114 or 116 that the called peer has come on-line. After the notification is sent or after the time-to-live period has ended the query is removed from presence service 220.

Presence service 220 refers to a mechanism by which a first peer/user receives at least notification about the availability of a second peer (i.e. its presentivity). When the first peer/user wants to be informed about presence information of the second peer, the first peer/user may subscribe to the presence information about the second peer (its presentivity). When the presence information about the second peer changes, the presence service sends a notification to the first peer/user directly. If the first peer/user is not on-line at that moment, the presence service may leave a notification in other peers following a prearranged rule between the first peer/user and the presence service. The presence service may be based on one or more presence servers, for example, outside the peer-to-peer network. In such a case, the first peer may subscribe with the presence servers and the second peer publishes its presence information to the presence servers. A presence server may send one or more notifications to the first peer/user.

At block 670, if a particular mail-box peer 112, 114 or 116 determines that called peer 118 has come on-line, the particular mail-box peer 112, 114 or 116 may communicate to called peer 118 the message or the message fragment or, otherwise, communicate that the message or the message is stored and that it is waiting for transfer to called peer 118.

In certain exemplary embodiments of the present invention, a multi-level messaging system may be used. In such a case, a primary level message may include the original message or message fragments destined for the called peer, while a secondary message includes the address of the peers to which the primary level message or message fragments have been transmitted. The secondary level message, therefore, includes pointers to and metadata about the primary level message, but may not include the primary level message. In such an exemplary embodiment, called peer 118 may first receive the secondary level message to facilitate the transfer of the primary level message.

Now referring to FIGS. 7A and 7B, at block 705, the message destined for called peer 118 of peer-to-peer network 100 or 200 is generated.

At block 710, calling peer 110 may determine if called peer 118 is off-line. At block 715, if called peer 118 is on-line (e.g., active and accessible), calling peer may send a primary level message destined for the called peer 118 for presentation at called peer 118. That is, the primary level message sent to called peer 118 may be sent via conventional peer-to-peer routing, since calling peer 110 and called peer 118 are both on-line. The primary level message may be processed by calling peer 110 prior to transmission to called peer 118 to fragment the message in preparation for packet transmission over a packet-type network such as the Internet and/or the primary level message may be encrypted to prevent discovery of the message content by those without the proper decryption key or keys. The called peer 118 may have been previously provided with such a decryption key.

If the called peer 118 is off-line, then, at block 720, a secondary level message may be generated that includes at least the addresses of respective mail-box peers 112, 114 and 116 to which the primary message or message fragments are to be transmitted.

At optional block 730, the primary and secondary level messages destined for called peer 118 may be partitioned into fragments, for example, for transmission over the Internet and/or to enable spreading of these messages over a large number of mail-box peers 112, 114 and 116. At optional block 740, the primary and secondary level messages destined for called peer 118 which may have been fragmented at block 730 may be encrypted.

At optional block 745, the primary and secondary level messages destined for called peer 118 which may have been fragmented and/or encrypted may be digitally signed.

At block 750, calling peer 110 may replicate the encrypted (or unencrypted) primary level message or message fragments that are destined for called peer 118 a first number of times (N times) and may replicate the encrypted (or unencrypted) secondary level message or message fragments that are destined for called peer 118 a second number of times (M times). N and M may be predetermined numbers and/or may be, for example, based on a probability that respective peers 110, 112, 114, 116 and 118 in peer-to-peer network 100 are on-line and on a desired reliability of message delivery. The probabilities may be based on an average probability or, otherwise, may include probabilities related to a portion or all of the individual peers on peer-to-peer network 100 or 200. Moreover M may desirably be larger then N. Because each secondary level message includes a relatively small amount of information, the cost in bandwidth of the P2P network of a larger number of replications and transfers is relatively small compared to the same number of primary level messages.

At block 760, calling peer 110 may transmit the N replicated primary level messages or replicated primary level message fragments corresponding to the N replicated primary level messages for storage at respective mail-box peers 112, 114 and 116 of peer-to-peer network 100. Mail-box peers 112, 114 and 116 used for storage of these message or message fragments may be selected randomly or in a quasi-random manner to increase security of the primary level message.

At block 770, the secondary level message may be replicated and transmitted, in a manner similar to that of the replicated primary level messages to mail-box peers 112, 114 and 116 that are identified as being accessible to called peer 118 and stored by those mail-box peers 112, 114 and 116 that are on-line. Accessible mail-box peers may refer to, for example, prearranged mail-box peers, neighboring peers, and successor peers, among others. It may be desirable that the secondary level message be encrypted and that addresses of any prearranged mail-box peers 112, 114 and 116 be kept secret to improve security. The secondary level messages may include metadata regarding the primary level messages including the addresses of the mail-box peers 112, 114 and 116 that store the primary level messages or the primary level message fragments. The metadata of each of the secondary level messages may include information indicating, for example: (1) the address of a respective portion or all of the stored primary level messages or message fragments; (2) the calling party; (3) the calling peer; (4) the priority of the message; (5) a time-to-live for the primary/secondary level message; and/or (6) whether a confirmation is requested by the calling party.

At block 780 (shown in FIG. 7B), the accessible mail-box peers may determine whether called peer 118 has come on-line (e.g., is active and accessible). The determination whether called peer 118 has come on-line may be based on: (1) called peer 118 notifying the accessible mail-box peers 112, 114 and 116 that it has come on-line; (2) each mail-box peer 112, 114 or 116 polling called peer 118 and determining whether called peer 118 has come on-line based on reception of a response from called peer 118 and/or (3) use of a presence service 220 for tracking the presence of the called peer and for notifying the accessible mail-box peers that called peer 118 is on-line.

At block 785, if a particular accessible mail-box peer 112, 114 or 116 determines that called peer 118 has come on-line, the particular accessible mail-box peer 112, 114 or 116 may communicate to called peer 118 the secondary level message or message fragment or, otherwise, communicate that it is storing the secondary level message to called peer 118.

If the secondary message is digitally signed at optional block 745, at optional block 788, the called peer 118 may determine whether the secondary level message or message fragment can be authenticated based on the digital signature of the secondary level message or secondary level message fragments (e.g., whether the digital signature from the calling peer 110 is proper). At block 789, if the digital signature can not be authenticated, the process may be terminated with respect to the particular secondary level message or message fragment communicated to the called peer 118.

If the process is not terminated at block 789, then at block 790, called peer 118 may notify one or more of the mail-box peers that are storing the primary level message or primary level message fragments to send it the primary level message or primary level message fragments.

At block 795, called peer 118 may receive the primary level message or primary level message fragments corresponding to the primary level message. The notification to the mail-box peers at block 790 and reception at block 795 may be accomplished in parallel or serially. That is, for example, called peer 118 may either broadcast a message to the mail-box peers that are storing the primary level message or, otherwise, systematically poll the mail-box peers that are storing the primary level message one-by-one. In the latter case, the polling message to the mail-box peers may include information about previously received message fragments so that these fragments are not redundantly sent on to called peer 118.

Referring to FIG. 8, for brevity, blocks 805, 810, 815, 830 and 840 of FIG. 8 which are the same as blocks 605, 610, 615, 630 and 640 of FIG. 6 are only briefly described.

At blocks, 805 and 810, the message is generated and it is determined whether the called peer is on-line. At block 815 if the called peer is on-line then the message is sent directly to it.

At block 820, if called peer 118 is off-line the message destined for called peer 118 may be compressed (either a lossless or a lossy compression). In the case of lossy compression, the quality (e.g., resolution and clarity) may be set to a predetermined level.

At block 850, the message which may by compressed, partitioned, encrypted and/or digitally signed at blocks 820, 830 and 840, respectively, may be sent to a predetermined number of other peers. The predetermined number is correlated to a threshold probability of successful communication of the message (compressed, partitioned and/or encrypted) to called peer 118.

At block 860, the sent message or message fragments may be stored at the other peers, for example peers 112, 114 and/or 116 that are on-line. That is, peers that are sent the message or message fragments that are on-line during the transfer may store the message or message fragments.

The selection of the other peers 112, 114 and 116 used for storage of the message or message fragments may be: (1) based on a random or quasi-random selection of the other peers 112, 114 or 116 (2) based on the locality of the other peers 112, 114 or 116 to called peer 118; and/or (3) preselected (i.e., prearranged).

At block 870, each of the other peers 112, 114 and 116 may determine if called peer 118 has come on-line (e.g., is active and accessible). The determination whether called peer 118 has come on-line may be based on: (1) called peer 118 notifying a prearranged group of mail-box peers 112, 114 and 116 that it has come on-line; (2) called peer 118 broadcasting that it has come on-line to other peers known (e.g., accessible) to it; (3) each mail-box peer 112, 114 or 116 polling called peer 118 and determining whether called peer 118 has come on-line based on reception of a response from called peer 118; and/or (4) use of a presence service 220

At block 880, if a particular other peer 112, 114 or 116 determines that called peer 118 has come on-line, the particular other peer 112, 114 or 116 may communicate to called peer 118 the message or the message fragment or, otherwise, communicate that the message or the message is stored and that it is waiting for transfer to called peer 118).

If the message or message fragments are digitally signed at optional block 840 then, at optional block 885, the called peer 118 may determine whether the message or message fragments can be authenticated based on the digital signature. At optional block 886, if the digital signature of a message or a message fragment is not authenticated, the process may be terminated with respect to the particular message or message fragment communicated to the called peer 118.

At block 890, the message may be provided to the user via the called peer 118. In certain embodiments that include compression, fragmentation and/or encryption, the message may be restored (based on inverse operation), i.e., decompression, reassemble of the message fragments and/or decryption, prior to it being provided to the user.

In certain embodiments that include the message being digitally signed the message may be authenticated prior to it being provided to the user and, although not shown, the process may be terminated with respect to the message if the message is not restored (based on inverse operation), i.e., decompression. If the message is restored, the process may, reassemble of the message fragments and/or decryption, prior to it being provided to the user.

Now referring to FIG. 9, for brevity, blocks 905, 910, and 915 of FIG. 9 which are the same as blocks 605, 610, and 615 of FIG. 6 are only briefly described.

At blocks 905 and 910, the message is generated and it is determined whether the called peer 118 is on-line. At block 915, if the called peer 118 is on-line then the message is sent directly to it.

At block 920, if called peer 118 is off-line, the message destined for called peer 118 may be decomposed into layers. For example, the message may be decomposed into a plurality of layers. One or a combination of respective layers may represent a version of the generated message. That is, each layer may individually represent a component of the decomposed message (as an example, a frequency component or a spatial component of the decomposed message) such that each layer may be combined with any other layer to generate an improved version of the decomposed message relative to the individual layers which were combined. Such a decomposition technique is referred to as progressive layering. Another decomposition technique is hierarchical layering in which at least a portion of the layers require other layers for reconstruction of the decomposed message. Examples of such a decomposition technique includes differential encoding scheme such as in the JPEG standard.

At optional block 930, if called peer 118 is off-line, the layers corresponding to the message destined for called peer 118 may be partitioned into fragments. At optional block 940, these layers destined for called peer 118 which may have been fragmented at block 930 may be encrypted. That is, if the layers are fragmented, each layer fragment may be encrypted individually and, otherwise, an entire layer may be encrypted.

At optional block 945, the layers destined for called peer 118 which may have been fragmented and/or encrypted may be digitally signed.

At block 950, the decomposed layers that correspond to the message which may be partitioned and/or encrypted at optional blocks 930 and 940, respectively, may be sent to selected other peers. These selected other peers may be predetermined. The number of selected peers may be correlated to a threshold probability of successful communication of a threshold quality of a reconstructed message corresponding to the original message to called peer 118. That is, each layer or layer fragment may be sent to the same or a different number of selected peers. The number of layers or layer fragments sent to respective peers may be a based on the quality (e.g., amount of information in the particular layer relative to the original message) of a particular layer, a probability that respective peers 112, 114 and 116 in peer-to-peer network 100 or 200 are on-line and a desired reliability of message delivery. That is, for example, high quality layers may be sent to more selected peers than lower quality layers.

At block 960, the sent layers or layer fragments may be stored at the other peers, for example peers 112, 114 and/or 116, that are on-line. That is, peers that are sent the layers or layer fragments that are on-line during the transfer may store them.

The selection of the other peers 112, 114 and 116 used for storage of the message or message fragments may be: (1) based on a random or quasi-random selection of the other peers 112, 114 or 116 (2) based on the locality of the other peers 112, 114 or 116 to called peer 118; and/or (3) preselected (i.e., prearranged).

At block 970, each of the other peers 112, 114 and 116 storing the layers or layer fragments may determine if called peer 118 has come on-line (e.g., is active and accessible). The determination whether called peer 118 has come on-line may be based on: (1) called peer 118 notifying a prearranged group of the other peers 112, 114 and 116 that it has come on-line; (2) called peer 118 broadcasting that it has come on-line to other peers known (e.g., accessible) to it; (3) each of the other peers 112, 114 or 116 polling called peer 118 and determining whether called peer 118 has come on-line based on reception of a response from called peer 118; and/or (4) use of a presence service 220.

At block 980, called peer 118 may receive one or more of the stored layers or layer fragments corresponding to the message destined for the called peer 118.

If the layers are digitally signed at optional block 945 then, at optional block 985, the called peer 118 may determine whether the layers are authenticated based on the digital signature. At optional block 986, if the digital signature of a particular layer or layer fragment is not authenticated, the process may be terminated with respect to the particular layer or layer fragment communicated to the called peer 118.

At block 990, a version of the message destined for the called peer is reconstructed based on the received and authenticated layers or layer fragments.

If one of the layers received that was not encrypted is higher in quality than a threshold level, that layer may be provided to the callee (i.e., the called user). Otherwise, if the original layers were fragmented or encrypted, these operations may be reversed (i.e., reassemble of the fragmented layers and/or decryption thereof). Moreover, the layers may be recombined to produce higher quality reconstructed versions of the original message compared to the uncombined layers.

At block 995, the message may be provided to the user via the called peer 118.

Exemplary embodiments of the present invention enable a layering based replication methods which may allow significant bandwidth (cost) saving. These replication methods enable scalable and reliable multimedia messaging services in P2P networks and, in particular, where peer on-line reliability is low (i.e., they are highly unreliable) for example, with portable consumer electronics devices. In such P2P networks, reliable messaging may be costly and, thus, a layering method may allow, a higher probability of partial message delivery as compared to a lower probability of complete message delivery for a non-layered method.

Although the invention has been described in terms of a messaging system, it is contemplated that the it may be implemented in software on microprocessors/general purpose computers (not shown). In various embodiments, one or more of the functions of the various components may be implemented in software that controls a general purpose computer. This software may be embodied in a computer readable carrier, for example, a magnetic or optical disk, a memory-card or an audio frequency, radio-frequency, or optical carrier wave.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for transmitting a message from a calling peer to a called peer in a peer-to-peer network, comprising the steps of:
determining, by the calling peer, if the called peer is off-line;
if the called peer is off-line, then
a) replicating the message a number of times N, and
b) transmitting the N replicated messages for storage at N respective peers.

2. The method according to claim 1, further comprising the step of: determining the number of times N from a probability that a peer in the peer-to-peer network is on-line and a desired reliability of message delivery.

3. The method according to claim 1, further including the step of encrypting each of the replicated messages before transmitting the replicated messages.

4. The method according to claim 1, further including the step of partitioning the message into fragments before replicating the message such that each of the fragments is replicated.

5. The method according to claim 1, further including the step of: when the called peer comes on-line, polling other peers to which the called peer has access to determine if the message is waiting.

6. The method according to claim 1, further including the step of: when the called peer comes on-line, causing the peers on which the message is stored to notify the called peer that the message is waiting.

7. The method according to claim 1, further comprising the step of: sending, by at least one of the N respective peers, at least one of the N replicated messages, responsive to a request from the called peer.

8. The method according to claim 1, further comprising the steps of:
determining, by at least one of the N respective peers, whether the called peer has come on-line; and
sending, by the at least one of the N respective peers, at least one of the N replicated messages, responsive to the called peer coming on-line.

9. The method according to claim 1, further including the steps of:
generating a primary level message including addresses of the peers to which the message was transmitted; and
transmitting the primary level message to peers that are identified as being accessible to the called peer.

10. The method according to claim 1, further including the steps of:
fragmenting the message into a plurality of parts;
assigning a respective priority to each of the message parts; and
replicating message parts having a higher priority more times than message parts having a lower priority.

11. The method according to claim 1, wherein the message is a primary level message, the method further including the steps of:
generating a secondary level message including addresses of the other peers to which the primary level message was transmitted; and
transmitting the secondary level message to other peers that are identified as being accessible to the called peer.

12. A method for transmitting a message from a calling peer to a called peer in a peer-to-peer network, the peer-to-peer network including a plurality of other peers, the method comprising the steps of:
responsive to the called peer being off-line,
compressing the message to generate a reproduction version representing the message that meets or exceeds a threshold quality,
transmitting the compressed message to at least a predetermined number of the other peers of the plurality of peers, and
storing the compressed message in at least the predetermined number of the other peers that are on-line; and
responsive to the called peer coming on-line, sending at least one of the stored compressed messages to the called peer.

13. A method for transmitting a message from a calling peer to a called peer in a peer-to-peer network, the peer-to-peer network including a plurality of other peers, the method comprising the steps of:
responsive to the called peer being off-line,
transmitting the message to at least a predetermined number of the other peers of the plurality of peers, and
storing the message in at least the predetermined number of the other peers that are on-line; and
responsive to the called peer coming on-line, sending at least one of the stored messages to the called peer.

14. The method according to claim 13, wherein the step of sending the at least one of the stored messages to the called peer is responsive to a request from the called peer.

15. The method according to claim 13, wherein the step of sending the at least one of the stored messages to the called peer further includes the step of:
determining, by at least one of the other peers having the stored message, whether the called peer is on-line; and
if the called peer is determined by the at least one of the other peers having the stored message to be on-line, transmitting, from the at least one of the other peers having the stored message, the at least one of the stored messages to the called peer.

16. A method for transmitting a message from a calling peer to a called peer in a peer-to-peer network, the peer-to-peer network including a plurality of other peers, the method comprising the steps of:
responsive to the called peer being off-line,
a) decomposing the message into a plurality of layers such that one or a combination of respective layers represents a version of the message;
b) selecting at least one of the respective layers of the decomposed message to meet or exceed a threshold quality for a reproduced version of the message;
c) transmitting the at least one of the respective layers of the decomposed message to a predetermined number of the other peers; and
d) storing the at least one of the respective layers of the decomposed message in the predetermined number of other peers that are on-line.

17. The method according to claim 13, further including the step of encrypting each of the respective layers of the decomposed messages prior to transmission in step (c).

18. The method according to claim 17, further including the step of partitioning the respective layers of the decomposed message into fragments prior to transmission at step (c) such that each of the fragments is transmitted.

19. The method according to claim 16, further including the step of, when the called peer comes on-line, polling other peers to which the called peer has access to determine if any respective layers of the decomposed message are being stored.

20. The method according to claim 19, wherein the polling of the other peers includes the steps of:
sending, to a first peer of the other peers to which the called peer has access, a request message to transmit any respective layers of the decomposed messages stored by the first peer;
receiving respective layers of the decomposed message from the first peer;
updating the request message with tracking information indicating which a one or ones of the respective layers have been received by the called peer; and
sending, to a further peer of the other peers to which the called peer has access, the updated request message to transmit any respective layers of the decomposed message stored by the further peer that are not indicated in the tracking information.

21. The method according to claim 16, further including the step of, when the called peer comes on-line, causing the other peers that are on-line and that have the respective layers of the decomposed message stored to notify the called peer of the stored respective layers of the decomposed message.

22. The method according to claim 16, further including the steps of:
fragmenting the message into a plurality of parts;
determining a priority for each of the message parts based on information content of the respective message part; and
transmitting respective message parts having a higher determined priority to more of the other peers in the peer-to-peer network than message parts having a lower priority.

23. The method according to claim 16, wherein the predetermined number of other peers is established from a probability that a peer in the peer-to-peer network is on-line and a desired reliability of message delivery.

24. The method according to claim 16, further comprising the steps of: responsive to the called peer coming on-line,
transmitting at least one of the predetermined number of stored respective layers of the decomposed message to the called peer; and
providing the transmitted at least one of the respective layers of the decomposed message to a user, as the version of the message.

25. The method according to claim 16, wherein:
step (c) of transmitting the at least one of the respective layers of the decomposed message includes:
c-1) sending a plurality of respective layers of the decomposed message such that a first layer is sent to the predetermined number of other peers and one or more further layers are sent to less than the predetermined number of other peers; and
step (d) of storing the at least one of the respective layers of the decomposed message in the predetermined number of other peers that are on-line includes:
d-1) storing the plurality of respective layers of the decomposed message such that the one or more further layers are stored in corresponding ones of the other peers that have been sent the further layers in step (c-1) and that are on-line.

26. The method according to claim 25, wherein the number of other peers being sent the one or more respective further layers is in accordance with information content of each respective further layer of the decomposed message.

27. The method according to claim 26, wherein:
the step of transmitting at least one of the predetermined number of stored respective layers of the decomposed message to the called peer includes transmitting each respective further layer to the called peer; and
the method further includes reconstructing the message based on combining the first and further layers received by the called peer.

28. A peer-to-peer network including a plurality of peers on the peer-to-peer network communicating therein, comprising:
a calling peer for generating a message from a caller;
a called peer of the plurality of peers for receiving the message and providing the message to a called user; and
storage peers of the plurality of peers for storing compressed or layered messages from the calling peer;
wherein, responsive to the called peer being off-line, the calling peer transmits the compressed or layered messages to a predetermined number of the storage peers that are on-line; and
wherein, responsive to the called peer coming on-line, one of the storage peers sends a respective message stored therein to the called peer.

29. A network, comprising:
a calling peer for sending replicated messages;
a called peer; and
a plurality of mail-box peers, the called peer receiving one or more replicated messages from the calling peer via one or more of the mail-box peers responsive to the called peer becoming available, each mail-box peer: (1) receiving and storing at least one respective message destined for the called peer when the called peer is unavailable; and (2) transmitting the at least one stored message to the called peer when to called peer becomes available.

30. The network according to claim 29, wherein:
the calling peer includes a decomposition unit for decomposing the message into a plurality of layers such that at least one combination of respective layers represents a version of the message, for selecting at least one combination of the respective layers of the decomposed message to meet or exceed a threshold quality for a reproduced version of the message, and for transmitting the at least one combination of the respective layers to a predetermined number of other peers of the plurality of peers; and
the called unit includes a recomposition unit for reconstructing the decomposed message by combining the at least one combination of the respective layers to produce the reconstructed version of the message.

31. A computer medium including program instruction to execute the method according to claim 1.
